(19) United States
(12) Patent Application Publication
(10) Pub. No.: US 2024/0093620 A1
(43) Pub. Date: Mar. 21, 2024

(54) UTILIZING AIR WASTE HEAT BOILER STACK GASES FROM DEHYDROGENATION UNITS

(71) Applicant: SABIC GLOBAL TECHNOLOGIES B.V., BERGEN OP ZOOM (NL)

(72) Inventors: Vijay Dinkar BODAS, Riyadh (SA); Mohammed Bismillah ANSARI, Riyadh (SA)

(73) Assignee: SABIC GLOBAL TECHNOLOGIES B.V., BERGEN OP ZOOM (NL)

(21) Appl. No.: 18/254,036

(22) PCT Filed: Nov. 23, 2021
(86) PCT No.: PCT/IB2021/060894

§ 371 Date: May 23, 2023

(30) Foreign Application Priority Data
Nov. 24, 2020 (EP) 20209417.3

(51) Int. Cl. F01K 3/18

(52) U.S. Cl. CPC F01K 3/188

(57) ABSTRACT

Systems and methods for producing heat and an oxidant for an endothermic chemical production process are disclosed. At least some process heat is recovered from (1) a hot gas including hot gas from a waste air vent of an MTBE production unit and/or (2) a catalyst regeneration process into a combustion gas stream. The combustion gas stream is further used in a steam reformer and/or a cracker for providing an oxidant and at least some heat.

### CROSS REFERENCE TO RELATED APPLICATIONS

This application claims the benefit of priority to European Patent Application No. 20209417.3, filed Nov. 24, 2020, the entire contents of which are hereby incorporated by reference in their entirety.

### FIELD OF INVENTION

The present invention generally relates to optimization of heat integration for endothermic chemical production processes. More specifically, the present invention relates to processes of recovering heat from one or more chemical production processes to provide reaction heat for an endothermic process.

### BACKGROUND OF THE INVENTION

Heat integration and optimization are imperative in the chemical industry for improving energy efficiency and lowering production costs. Generally, at least a portion of heat needed by endothermic chemical reactions and/or processes can be provided by other exothermic chemical production processes, such that the need for heat via directly burning fuel is mitigated.

Steam reforming is an endothermic chemical production process that can be used to produce various chemicals including methanol, ammonia, 2-ethylhexanol, and steel. Currently, the energy efficiency for conventional steam reforming processes is limited due to poor heat recovery and heat integration. For instance, the conventional steam reformer generally uses air that is compressed by a forced draft fan and preheats the compressed air in an air preheater when the system includes induced and forced draft fans in the furnace design. In cases where the system does not include the draft fan or the induced draft fan, a natural draft is directly taken from the atmosphere. Thus, either way, conventional steam reforming systems utilize air at ambient temperature as source of combustion gas and have low energy efficiency and high production cost.

Overall, while systems and methods for providing heat for endothermic processes (e.g., a steam reforming process) exist, the need for improvements in this field persists in light of at least the aforementioned drawback for the conventional systems and methods.

### BRIEF SUMMARY OF THE INVENTION

A solution to at least the above mentioned problem associated with the systems and methods for providing heat to endothermic chemical processes is discovered. The solution resides in a method for producing one or more compounds by an endothermic reaction that includes providing heat and an oxidant to the endothermic reaction from an exhaust gas emanating from a catalyst regeneration process. This can be beneficial for at least recovering heat from the catalyst regeneration process, thereby improving energy efficiency for producing the one or more compounds. Additionally, the method can include recovering at least some heat from hot gas from a waste air vent of an MTBE production unit, further recovering heat from waste streams and increasing the energy efficiency for producing the compounds. Furthermore, the disclosed systems and methods can include a fixed damper installed upstream of a heat boiler stack for heating combustion gas of the endothermic chemical production processes. The fixed damper is configured to provide a back pressure, which in turn transports the combustion gas the furnace uses for the endothermic chemical production processes, resulting in reduced energy consumption for transporting the combustion gas. Therefore, the systems and methods of the present invention provide a technical solution to the problem associated with the conventional systems and methods for providing heat for endothermic chemical production processes.

Embodiments of the invention include a method of producing one or more compounds by an endothermic reaction. The method comprises providing heat and an oxidant to the endothermic reaction from an exhaust gas emanating from a catalyst regeneration process.

Embodiments of the invention include a method of producing heat and an oxidant for an endothermic chemical production process. The method comprises combusting, in a gas turbine unit, a mixture of (1) a fuel and (2) a first stream comprising air to produce a turbine exhaust gas stream. The method comprises regenerating a catalyst of a catalytic reactor using the turbine exhaust gas stream as a regeneration gas stream to produce a regeneration exhaust gas stream. The method comprises processing the regeneration exhaust gas stream and/or the turbine exhaust gas stream to produce at least a portion of a combustion gas stream for the endothermic chemical production process.

Embodiments of the invention include a method of producing heat and an oxidant for an endothermic chemical production process. The method comprises combusting, in a gas turbine unit, a mixture of (1) a fuel and (2) a first stream comprising air to produce a turbine exhaust gas stream. The method comprises compressing a hot gas (e.g., hot gas from a waste air vent of an MTBE production unit) to produce a high pressure gas stream. The method comprises combusting a fuel in the high pressure gas stream to produce a regeneration gas stream. The method comprises regenerating, using the regeneration gas stream, a catalyst of a hydrocarbon dehydrogenation unit to produce an exhaust gas stream. The method comprises processing the exhaust gas stream and/or the turbine exhaust gas stream to produce at least a portion of a combustion gas comprising the oxidant for the endothermic chemical production process.

Embodiments of the invention include a method of producing heat and an oxidant for an endothermic chemical production process. The method comprises flowing a first stream comprising air and at least some fuel to a gas turbine unit. The method comprises combusting, in the gas turbine unit, the fuel in the first stream to (1) produce a turbine exhaust gas stream and (2) drive an air compressor. The method comprises processing hot gas stream from a waste air vent of an MTBE production unit to produce a regeneration gas stream. The processing of the first regeneration gas stream includes compressing the hot gas stream in the air compressor to produce a high pressure stream. The processing of the first regeneration gas stream further still includes combusting fuel in the high pressure gas stream to produce the regeneration gas stream. The method comprises regenerating, using the regeneration gas stream, a catalyst of a hydrocarbon dehydrogenation unit to produce a regeneration exhaust gas stream. The method comprises processing the regeneration exhaust gas stream and/or the turbine exhaust gas stream to produce at least a portion of a combustion gas comprising the oxidant for the endothermic chemical production process.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a system for producing one or more compounds by an endothermic reaction, according to embodiments of the invention; and

FIG. 2 shows a schematic flowchart of a method for producing one or more compounds by an endothermic reaction, according to embodiments of the invention.

### DETAILED DESCRIPTION OF THE INVENTION

Currently, combustion air for a reformer is either provided by compressing ambient air using a forced draft fan and preheated in an air preheater, or directly flowing ambient air into the furnace by natural draft. In both cases, the combustion air is obtained directly from the atmosphere at an ambient temperature without any heat recovery from other units or processes. The energy efficiency for the conventional reformer is relatively low. The present invention provides a solution to this problem. The solution is premised on a method of producing one or more compounds by an endothermic reaction that includes providing heat and an oxidant to the endothermic reaction from at least an exhaust gas from a catalyst regeneration process. Furthermore, at least some heat of the exhaust gas can be recovered from (1) a hot gas from an exhaust vent of an MTBE production unit and (2) the catalyst regeneration process. Hence, the disclosed method is capable of improving energy cost for heating up the combustion air used for the endothermic reaction compared to conventional methods, which do not include a substantial heat recovery process. These and other non-limiting aspects of the present invention are discussed in further detail in the following sections.

A. System for Processing C₃ and C₄ Hydrocarbon Mixture

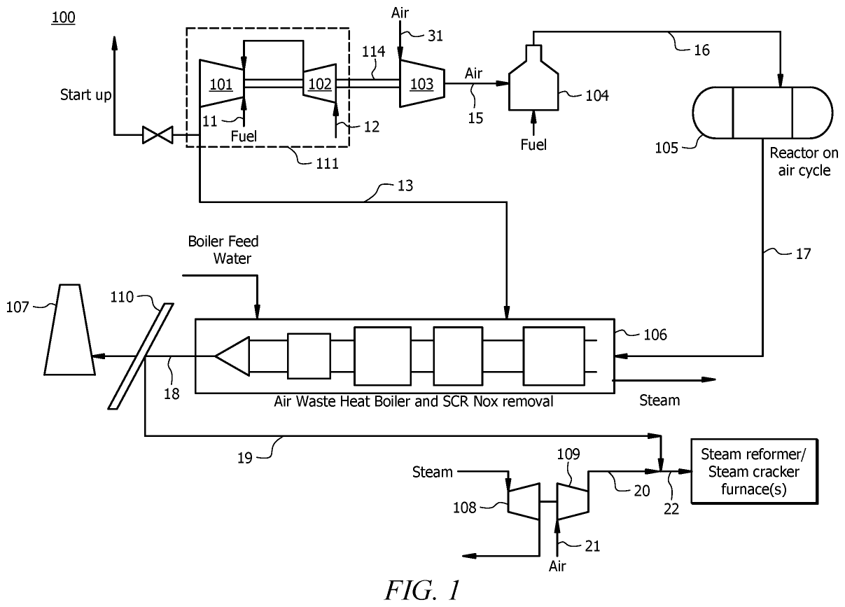

In embodiments of the invention, the system for producing one or more compounds by an endothermic reaction includes a gas turbine, a dehydrogenation unit, an air waste heat boiler stack, and a forced draft fan. Notably, the system is capable of reducing energy consumption and increasing efficiency for producing one or more compounds by an endothermic reaction compared to conventional systems. With reference to FIG. 1, a schematic diagram is shown for system 100, which is used for producing one or more compounds by an endothermic reaction.

According to embodiments of the invention, system 100 includes gas turbine unit 111 (combination of 101 and 102) configured to combust a fuel of first fuel stream 11 and first stream 12 to produce turbine exhaust gas stream 13. Gas turbine unit 111 may include a single turbine, or two or more gas turbines operated in parallel or in series. Gas turbine unit 111 is further configured to drive process air compressor 103 via shaft 114. First stream 12 can include air. The air of first stream 12 may be under ambient conditions. In embodiments of the invention, the fuel of first fuel stream 11 includes natural gas, hydrogen, methane, ethane, carbon monoxide, carbon dioxide, or combinations thereof. The hydrogen of first fuel stream 11 may be produced and recovered from a hydrocarbon dehydrogenation process.

In embodiments of the invention, process air compressor 103 can be an air compressor of a hydrocarbon dehydrogenation unit. The dehydrogenation unit can include an n-butane dehydrogenation unit, an isobutane dehydrogenation unit, a propane dehydrogenation unit, an isopentane dehydrogenation unit, a propane dehydrogenation unit, or combinations thereof. Process air compressor 103 is configured to compress inlet gas stream 31 to form high pressure gas stream 15. Inlet gas stream 31 may include an air stream. The air may comply with international standard with 60 to 85% relative humidity. Inlet gas stream 31 may be at ambient temperature. Inlet gas stream 31 may be a hot gas stream from a waste air vent of an MTBE production unit. According to embodiments of the invention, the hot gas stream from a waste air vent of an MTBE production unit comprises oxygen, nitrogen, carbon dioxide, carbon monoxide, oxides of sulfur and/or nitrogen, or combinations thereof. High pressure gas stream 15 may be at a pressure of 2.2 to 3 bar (abs) and all ranges and values there between.

According to embodiments of the invention, an outlet of process air compressor 103 is in fluid communication with an inlet of air heater 104 such that high pressure gas stream 15 flows from process air compressor 103 to air heater 104. Air heater 104 may be configured to combust a fuel and high pressure gas stream 15 to produce regeneration stream 16. In embodiments of the invention, regeneration gas stream 16 is at a temperature of 600 to 730° C. and all ranges and values there between including ranges of 600 to 610° C., 610 to 620° C., 620 to 630° C., 630 to 640° C., 640 to 650° C., 650 to 660° C., 660 to 670° C., 670 to 680° C., 680 to 690° C., 690 to 700° C., 700 to 710° C., 710 to 720° C., and 720 to 730° C. In embodiments of the invention, regeneration gas stream 16 includes 1 to 15 vol. % oxygen gas, 74 to 79 vol. % nitrogen gas, 2 to 4 vol. % CO₂, 5 to 8 vol. % water vapor, and minor amount of argon.

In embodiments of the invention, an outlet of air heater 104 is in fluid communication with an inlet of catalytic reactor 105 such that regeneration gas stream 16 flows from air heater 104 to catalytic reactor 105. Catalytic reactor 105 comprises a catalyst disposed therein. Catalytic reactor 105, in embodiments of the invention, can include a dehydrogenation reactor configured to catalytically dehydrogenate a hydrocarbon to produce one or more unsaturated hydrocarbons. The dehydrogenation reactor can include an n-butane dehydrogenation reactor, an isobutane dehydrogenation reactor, a propane dehydrogenation reactor, and/or an isopentane dehydrogenation reactor.

In embodiments of the invention, catalytic reactor 105 is in regeneration mode and regeneration gas stream 16 is configured to regenerate spent catalyst of catalytic reactor 105 to produce regenerated catalyst and regeneration exhaust stream 17. In embodiments of the invention, regeneration exhaust stream 17 is at a temperature in a range of 530 to 560° C. Regeneration exhaust stream 17 may include 1 to 15 vol. % oxygen.

According to embodiments of the invention, an outlet of catalytic reactor 105 is in fluid communication with air waste heat boiler and NOX removal unit 106 such that regeneration exhaust stream 17 flows from catalytic reactor 105 to air waste heat boiler and NOX removal unit 106. In embodiments of the invention, air waste heat boiler and NOX removal unit 106 is configured to heat boiler feed water by using at least a portion of regeneration exhaust stream 17 and/or at least a portion of turbine exhaust gas stream 13 as a heating medium to produce steam and/or superheated steam, and/or remove nitrogen oxides from regeneration exhaust stream 17 to produce first cooled exhaust gas stream 18. In embodiments of the invention, air waste heat boiler and NOX removal unit 106 comprises selective catalytic NOx removal system for removing nitrogen oxides. In embodiments of the invention, air waste heat boiler and NOX removal unit 106 further comprises a boiler coil, an economizer coil, a heat exchanger, or combinations thereof.

As an alternative to, or in addition to using at least a portion of turbine exhaust gas stream 13 as a heating medium for air waste heat boiler and NOX removal unit 106, at least a portion of turbine exhaust gas stream 13 may be flowed into catalytic reactor 105 as regeneration gas for regenerating the catalyst therein. In embodiments of the invention, gas turbine unit 111 can include two gas turbines operated in parallel. The two gas turbines can be configured to supply turbine exhaust gas stream 13 to catalytic reactor 105 as a regeneration gas.

According to embodiments of the invention, an outlet of air waste heat boiler and NOX removal unit 106 is in fluid communication with an inlet of air waste heat boiler stack 107 such that at least a portion of first cooled exhaust stream 18 flows from air waste heat boiler and NOX removal unit 106 to air waste heat boiler stack 107. In embodiments of the invention, at least a portion of first cooled exhaust gas stream 18 can form flue gas stream 19. Flue gas stream 19 may be at a temperature of 230 to 240° C. Flue gas stream 19 may include 1 to 15 vol. % oxygen. In embodiments of the invention, process air compressor 103, air heater 104, catalytic reactor 105, air waste heat boiler and NOX removal unit 106, and/or air waste heat boiler stack 107 may be part of a hydrocarbon dehydrogenation unit.

According to embodiments of the invention, baffle damper 110 may be installed between an outlet of air waste heat boiler and NOX removal unit 106 and an inlet of air waste heat boiler stack 107. Baffle damper 110, in embodiments of the invention, is configured to generate a back pressure for flue gas stream 19. The back pressure can be configured to flow flue gas stream 19 from baffle damper 110 to an outlet (duct from an outlet) of forced draft fan 109. In embodiments of the invention, forced draft fan 109 is configured to compress third combustion gas stream 21 to form compressed third combustion gas stream 20. Third combustion gas stream 21 may include air. Compressed third combustion gas stream 20 may be at a pressure of 200 to 400 mmH₂O, and a temperature of 15 to 16° C. Flue gas stream 19 may be combined with compressed third combustion gas stream 21 to form fourth combustion gas stream 22.

In embodiments of the invention, fourth combustion gas stream 22 is flowed to a steam reformer to provide an oxidant and at least some heat for one or more steam reforming reactions. The steam reformer may include a steam reformer for producing methanol, ammonia, 2-ethylhexanol, steel, or combinations thereof. Fourth combustion gas stream 22 may be flowed to a furnace of the steam reformer. In embodiments of the invention, fourth combustion gas stream 22 may be flowed to a cracker. The cracker may be configured to crack ethane, propane, butanes, pentanes, or combinations thereof to produce olefins and/or other unsaturated hydrocarbons. In embodiments of the invention, the cracker may include a steam cracker. According to embodiments of the invention, system 100 further comprises steam turbine driver 108 configured to drive forced draft fan 109 to pressurize third combustion gas stream 21. According to embodiments of the invention, a switch mechanism can be installed between system 100 and the steam reformer. The switch mechanism can be configured to ensure the steam reformer and system 100 can each be individually operated, if needed. The switch mechanism can include one or more valves.

### B. Method of Producing Compounds by Endothermic Reaction

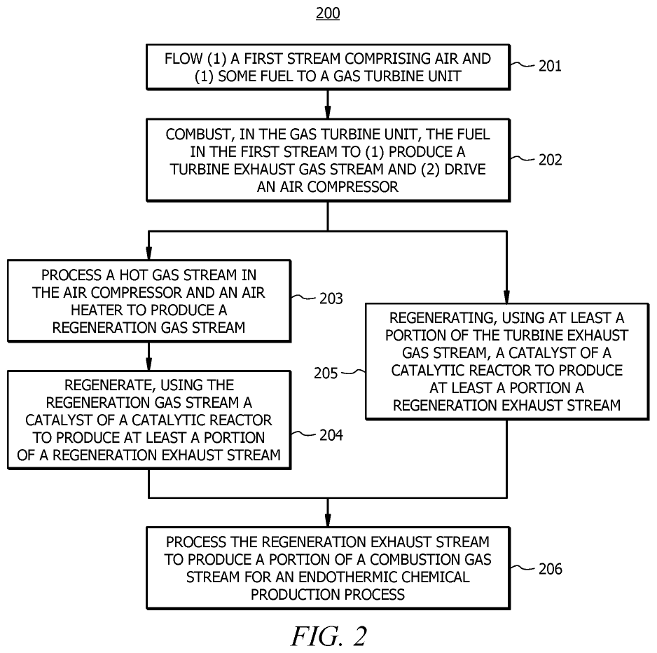

Methods of producing one or more compounds by an endothermic reaction have been discovered. As shown in FIG. 2, embodiments of the invention include method 200 for producing heat and an oxidant for an endothermic chemical production process with improved energy efficiency and reduced production cost compared to conventional methods. Method 200 may be implemented by system 100, as shown in FIG. 1 and described above.

According to embodiments of the invention, as shown in block 201, method 200 includes flowing first stream 12 and some fuel of first fuel stream 11 to gas turbine unit 111. In embodiments of the invention, first stream 12 includes ambient air. Fuel stream 11 may include natural gas, hydrogen gas, carbon monoxide, methane, ethane, carbon dioxide, or combinations thereof. In embodiments of the invention, the hydrogen gas of first fuel stream 11 is recovered from a catalytic dehydrogenation process.

According to embodiments of the invention, as shown in block 202, method 200 may include combusting, in gas turbine unit 111, the fuel and first stream 12 to drive process air compressor 103 and produce turbine exhaust gas stream 13. In embodiments of the invention, turbine exhaust gas stream 13 is at a temperature of 500 to 650° C. and all ranges and values there between including ranges of 500 to 510° C., 510 to 520° C., 520 to 530° C., 530 to 540° C., 540 to 550° C., 550 to 560° C., 560 to 570° C., 570 to 580° C., 580 to 590° C., 590 to 600° C., 600 to 610° C., 610 to 620° C., 620 to 630° C., 630 to 640° C., and 640 to 650° C. Turbine exhaust gas stream 13 may include 3 to 6 vol. % CO₂, 73 to 76 vol. % nitrogen, 12 to 15 vol. % oxygen, 6 to 8 vol. % water vapor.

According to embodiments of the invention, as shown in block 203, method 200 includes processing inlet gas stream 31 in air compressor 103 and air heater 104 to produce regeneration gas stream 16. Inlet gas stream 31 can include air, and/or a hot gas from a waste air vent of an MTBE production unit. The hot gas stream from a waste air vent of an MTBE production unit comprises oxygen, nitrogen, carbon dioxide, carbon monoxide, oxides of sulfur and/or nitrogen, or combinations thereof. In embodiments of the invention, regeneration gas stream 16 is at a temperature of 600 to 730° C. and all ranges and values there between including ranges of 600 to 610° C., 610 to 620° C., 620 to 630° C., 630 to 640° C., 640 to 650° C., 650 to 660° C., 660 to 670° C., 670 to 680° C., 680 to 690° C., 690 to 700° C., 700 to 710° C., 710 to 720° C., and 720 to 730° C. In embodiments of the invention, regeneration gas stream 16 includes 1 to 15 vol. % oxygen gas, 74 to 79 vol. % nitrogen gas, 2 to 4 vol. % CO₂, and 5 to 8 vol. % water vapor.

Processing at block 203 may include compressing inlet gas stream 31 in process air compressor 103 to produce high pressure gas stream 15. In embodiments of the invention, high pressure gas stream 15 may be at a pressure of 2.2 to 3 bar (abs). Processing at block 203 may further include combusting, in air heater 104, some fuel with high pressure gas stream 15 to produce regeneration gas stream 16. Regeneration gas stream 16 may be at a temperature of 600 to 730° C. and all ranges and values there between including ranges of 600 to 610° C., 610 to 620° C., 620 to 630° C., 630 to 640° C., 640 to 650° C., 650 to 660° C., 660 to 670° C., 670 to 680° C., 680 to 690° C., 690 to 700° C., 700 to 710° C., 710 to 720° C., and 720 to 730° C. Regeneration gas stream 16 may include 1 to 15 vol. % oxygen. Regeneration gas stream 16 may be at a pressure of 2 to 3 bar (abs).

According to embodiments of the invention, as shown in block 204, method 200 includes regenerating, using regeneration gas stream 16, a catalyst of catalytic reactor 105 to produce at least a portion of regeneration exhaust stream 17. In embodiments of the invention, the catalyst includes spent catalyst in need of regeneration. Regenerating at block 204 may be conducted at temperature of 650 to 700° C. Regeneration exhaust stream 17 may be at a temperature in a range of 530 to 560° C. Regeneration exhaust stream 17 may include 1 to 15 vol. % oxygen. Regeneration exhaust stream 17 may further include 2 to 4 vol. % CO₂, 5 to 8 vol. % water vapor and minor amounts of argon. As an alternative or in addition to block 204, as shown in block 205, method 200 includes regenerating, using at least a portion of turbine exhaust gas stream 13, the catalyst of catalytic reactor 105 to produce at least a portion of regeneration exhaust stream 17.

According to embodiments of the invention, as shown in block 206, method 200 includes processing regeneration exhaust stream 17 to produce at least a portion of fourth combustion gas stream 22. In embodiments of the invention, processing at block 206 includes using regeneration exhaust stream 17 to heat boiler feed water and produce steam and/or superheated steam (and thereby cool regeneration exhaust stream 17) and/or removing nitrogen oxides from regeneration exhaust stream 17 and/or turbine exhaust gas stream 13 in air waste boiler and NOX removal unit 106 to produce first cooled exhaust gas stream 18. In embodiments of the invention, first cooled exhaust gas stream 18 comprises less than 10 ppmy/y (dry) at 15% reference oxygen content of nitrogen oxides. First cooled exhaust gas stream 18 may be at a temperature of 230 to 240° C. At least a portion of first cooled exhaust gas stream 18 can form flue gas stream 19. Flue gas stream 19 may be at a temperature of 230 to 240° C. Processing at block 206, in embodiments of the invention, includes generating, by baffle damper 110, a back pressure in flue gas stream 19 such that flue gas stream 19 flows to (1) an outlet of forced draft fan 109 for a steam reformer and/or (2) duct work of a cracker (e.g., duct work of a furnace of a steam cracker). Flue gas stream 19 can form at least a portion fourth combustion gas stream 22 for one or more endothermic reactions, for providing at least some heat for the endothermic reactions and oxygen for supporting combustion of a fuel in the furnace of the steam reformer and/or a steam cracker. The steam reformer may include a steam reformer for producing methanol, ammonia, 2-ethylhexanol, steel, or combinations thereof. The cracker may be a steam cracker configured to crack ethane, propane, butanes, pentanes, or combinations thereof. Fourth combustion gas stream 22 may be flowed to a furnace of the steam reformer and/or the steam cracker. In embodiments of the invention, the back pressure is in a range of about 500 to 800 millimeter of water column (mmH₂O) and all ranges and values there between including ranges of 500 to 550 mmH₂O, 550 to 600 mmH₂O, 600 to 650 mmH₂O, 650 to 700 mmH₂O, 700 to 750 mmH₂O, and 750 to 800 mmH₂O.

In embodiments of the invention, flue gas stream 19 may be combined with third combustion gas stream 20 to form fourth combustion gas stream 22. In embodiments of the invention, third combustion gas stream 20 is produced by compressing third combustion gas stream 21 in forced draft fan 109. Third combustion gas stream 21 can include air. According to embodiments of the invention, flue gas stream 19 may be combined with third combustion gas stream 20 to form fourth combustion gas stream 22 so that flue gas stream 19 is at a 26 vol. % of fourth combustion gas stream 22. In embodiments of the invention, fourth combustion gas stream 22 comprises 15 to 21 vol. % oxygen. Fourth combustion gas stream 22 may further include less than 1% CO₂, about 3 to 4% water vapor, and 76 to 79% nitrogen. Fourth combustion gas stream 22 may be at a temperature of 150 to 250° C. and all ranges and values there between including ranges of 150 to 160° C., 160 to 170° C., 170 to 180° C., 180 to 190° C., 190 to 200° C., 200 to 210° C., 210 to 220° C., 220 to 230° C., 230 to 240° C., and 240 to 250° C. Fourth combustion gas stream 22 may include 15 to 21 vol. % oxygen and all ranges and values there between including ranges of 15 to 16 vol. %, 16 to 17 vol. %, 17 to 18 vol. %, 18 to 19 vol. %, 19 to 20 vol. %, and 20 to 21 vol. %. Fourth combustion gas stream 22 may be at a pressure of 200 to 300 mmH₂O and all ranges and values there between including ranges of 200 to 210 mmH₂O, 210 to 220 mmH₂O, 220 to 230 mmH₂O, 230 to 240 mmH₂O, 240 to 250 mmH₂O, 250 to 260 mmH₂O, 260 to 270 mmH₂O, 270 to 280 mmH₂O, 280 to 290 mmH₂O, and 290 to 300 mmH₂O. According to embodiments of the invention, fourth combustion gas stream 22 is used to provide oxidant and/or heat for a furnace of a steam reformer and/or steam cracker.

Although embodiments of the present invention have been described with reference to blocks of FIG. 2, it should be appreciated that operation of the present invention is not limited to the particular blocks and/or the particular order of the blocks illustrated in FIG. 2. Accordingly, embodiments of the invention may provide functionality as described herein using various blocks in a sequence different than that of FIG. 2

The systems and processes described herein can also include various equipment that is not shown and is known to one of skill in the art of chemical processing. For example, some controllers, piping, computers, valves, pumps, heaters, thermocouples, pressure indicators, mixers, heat exchangers, and the like may not be shown.

As part of the disclosure of the present invention, specific examples are included below. The examples are for illustrative purposes only and are not intended to limit the invention. Those of ordinary skill in the art will readily recognize parameters that can be changed or modified to yield essentially the same results.

### Example

### Heat Balance for a Methanol Reforming Furnace Using a Heat Recovery Process

Table 1 shows comparison of process stream compositions of (A) a conventional methanol reformer and (B) a system and a method according to embodiments of the invention. The 6 columns on the right side of Table 1 shows the simulated operating data for the system according to embodiments of the invention. The 5 columns on the left of Table 1 shows experimental operating data of a conventional reformer. Purge in Table 1 means purge gas from synthesis loop. NG in Table 1 means natural gas that is fired into the reformed fire box as fuel (not shown in FIG. 1). Air in Table 1 means third combustion gas stream 21 of FIG. 1. GT exhaust in Table 1 means gas turbine exhaust stream 13. Hot air and hot mixed air in Table 1 means inlet gas stream 31. Flue gas in Table 1 means flue gas emanating from reformer fire box that is not shown in FIG. 1. The results show that, compared to conventional methanol reformer, the system and method according to embodiments of the invention were capable of reducing fuel gas (natural gas, NG in Table 1) consumption for heating the furnace of methanol reformer by heat recovery from operation of a hydrocarbon dehydrogenation unit.

TABLE 1

| | | | | | | | Case with stream 1 flow added to combustion air | | | | | |
|---|---|---|---|---|---|---|---|---|---|---|---|---|
| | | | | | | | | | | | Hot | |
| | Case with no stream 1flow | | | | | | | | | GT | Mixed | |
| | Purge | NG | Air | Hot Air | Flue Gas | | Purge | NG | Air | Exhaust | Air | Flue Gas |
| | vol/vol | vol/vol | vol/vol | vol/vol | vol/vol | | vol/vol | vol/vol | vol/vol | vol/vol | vol/vol | vol/vol |
| H2 | 76.24% | 0.00% | 0.00% | 0.00% | 0.00% | | 76.24% | 0.00% | 0.00% | 0.00% | 0.00% | 0.00% |
| N2 | 1.33% | 1.44% | 77.13% | 77.13% | 67.90% | | 1.33% | 1.44% | 77.13% | 75.77% | 76.85% | 68.21% |
| O2 | 0.00% | 0.00% | 20.50% | 20.50% | 1.63% | | 0.00% | 0.00% | 20.50% | 13.76% | 19.11% | 1.54% |
| CO | 3.66% | 0.00% | 0.00% | 0.00% | 0.00% | | 3.66% | 0.00% | 0.00% | 0.00% | 0.00% | 0.00% |
| CO2 | 3.83% | 0.35% | 0.00% | 0.00% | 6.23% | | 3.83% | 0.35% | 0.00% | 3.26% | 0.67% | 6.45% |
| CH4 | 14.93% | 75.11% | 0.00% | 0.00% | 0.00% | | 14.99% | 75.11% | 0.00% | 0.00% | 0.00% | 0.00% |
| C2H6 | 0.00% | 20.00% | 0.00% | 0.00% | 0.00% | | 0.00% | 20.00% | 0.00% | 0.00% | 0.00% | 0.00% |
| C3H8 | 0.00% | 3.10% | 0.00% | 0.00% | 0.00% | | 0.00% | 3.10% | 0.00% | 0.00% | 0.00% | 0.00% |
| H2O | 0.01% | 0.00% | 2.37% | 2.37% | 24.24% | | 0.01% | 0.00% | 2.37% | 7.21% | 3.37% | 23.81% |
| | 100.00% | 100.00% | 100.00% | 100.00% | 100.00% | | 100.00% | 100.00% | 100.00% | 100.00% | 100.00% | 100.00% |
| WET total | 3469.8 | 411.1763 | 18202.37 | 18202.37 | 20751.9 | Kgmol/hr | 3469.8 | 11.67 | 15498.40 | 4029.584 | 19527.99 | 22077.51 |
| Deg C | 35-45 | 35-45 | 35-45 | 310-330 | 210-240 | | 35-45 | 35-45 | 35-45 | 210 | 400 | 210-240 |

In the context of the present invention, at least the following 16 embodiments are described. Embodiment 1 is a method of producing one or more compounds by an endothermic reaction. The method includes providing heat and an oxidant to the endothermic reaction from an exhaust gas emanating from a catalyst regeneration process.

Embodiment 2 is a method of producing heat and an oxidant for an endothermic chemical production process. The method includes combusting, in a gas turbine unit, a mixture of (1) a fuel in (2) a hot gas from a waste air vent of an MTBE production unit to produce a turbine exhaust gas stream. The method further includes regenerating, using the turbine exhaust gas stream, a catalyst of a hydrocarbon dehydrogenation unit to produce a regeneration exhaust gas stream. The method still further includes processing the regeneration exhaust gas stream to produce at least a portion of a combustion gas containing the oxidant for the endothermic chemical production process.

Embodiment 3 is a method of producing heat and an oxidant for an endothermic chemical production process. The method includes flowing air and at least some fuel to a gas turbine unit. The method further includes combusting, in the gas turbine unit, the fuel in the air to produce a turbine exhaust stream and drive an air compressor. The method still further includes processing a hot gas stream in the air compressor and an air heater to produce a regeneration gas stream. The method also includes regenerating, using the regeneration gas stream, a catalyst of a hydrocarbon dehydrogenation unit to produce a regeneration exhaust gas stream. In addition, the method includes processing the regeneration exhaust gas stream to produce at least a portion of a combustion gas containing the oxidant for the endothermic chemical production process, wherein the endothermic chemical production process includes a steam reforming process, and/or a steam cracking process. Embodiment 4 is the method of embodiment 3, wherein the processing of the hot gas stream includes compressing the hot gas stream in the air compressor to produce a high pressure gas stream. The method further includes combusting a fuel with the high pressure gas stream to produce the regeneration gas stream. Embodiment 5 is the method of either of embodiments 3 or 4, wherein the regeneration gas stream contains 1 to 15 vol. % oxygen gas. Embodiment 6 is the method of any of embodiments 3 to 5, wherein the regeneration gas stream is at a temperature of 600 to 730° C. and a pressure of 1 to 2 bar. Embodiment 7 is the method of any of embodiments 2 to 6, wherein the hot gas stream is a hot gas from a waste air vent of an MTBE production unit. Embodiment 8 is the method of embodiment 7, wherein the hot gas from the waste air vent of the MTBE production unit contains 1 to 15 wt. % oxygen gas. Embodiment 9 is the method of any of claims 2 to 8, wherein the processing of the regeneration exhaust gas stream includes cooling and/or removing nitrogen oxides from the exhaust gas stream in an air waste boiler and NOX removal unit to produce a first cooled exhaust stream. The method further includes flowing at least a portion of the first cooled exhaust stream to form a flue gas stream. The method still further includes generating, by a baffle damper installed upstream to an air waste heat boiler stack, a back pressure in the flue gas stream such that the flue gas stream flows to (1) an outlet of forced draft fan for a stream reformer and/or (2) duct work of a furnace of steam cracker. Embodiment 10 is the method of embodiment 9, wherein the back pressure is configured to drive flow of the combustion gas to the endothermic chemical production process. Embodiment 11 is the method of embodiment 10, wherein the back pressure is in a range of about 500-800 millimeters of water column. Embodiment 12 is the method of any of embodiments 2 to 11, wherein the endothermic chemical production process includes a steam cracking process and/or a steam reforming process, wherein the steam reforming process includes a steam reforming process for producing methanol, a steam reforming process for producing ammonia, a steam reforming process for producing steel, a steam reforming process for producing 2-ethylhexanol, or combinations thereof. Embodiment 13 is the method of any of embodiments 2 to 12, wherein the dehydrogenation unit includes an n-butane dehydrogenation unit, an isobutane dehydrogenation unit, a propane dehydrogenation unit, an isopentane dehydrogenation unit, or combinations thereof. Embodiment 14 is the method of any of embodiments 2 to 13, wherein the hot gas from the waste air vent from the MTBE production unit further contains nitrogen, carbon dioxide, carbon monoxide, oxides of sulfur and/or nitrogen, or combinations thereof. Embodiment 15 is the method of any of embodiments 2 to 14, wherein the hot gas from the waste air vent of the MTBE production unit is at a temperature of 150 to 250° C. Embodiment 16 is the method of any of embodiments 2 to 15, wherein the combustion gas contains 15 to 21 vol. % oxygen, and the combustion gas is at a temperature of 150 to 250° C. and a pressure of 200 to 300 millimeters water column.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method of producing one or more compounds by an endothermic reaction, the method comprising:
providing heat and an oxidant to the endothermic reaction from an exhaust gas emanating from a catalyst regeneration process.

2. A method of producing heat and an oxidant for an endothermic chemical production process, the method comprising:
combusting, in a gas turbine unit, a mixture of (1) a fuel in (2) a hot gas from a waste air vent of an MTBE production unit to produce a turbine exhaust gas stream;
regenerating, using the turbine exhaust gas stream, a catalyst of a hydrocarbon dehydrogenation unit to produce a regeneration exhaust gas stream; and
processing the regeneration exhaust gas stream to produce at least a portion of a combustion gas comprising the oxidant for the endothermic chemical production process.

3. A method of producing heat and an oxidant for an endothermic chemical production process, the method comprising:
flowing air and at least some fuel to a gas turbine unit;
combusting, in the gas turbine unit, the fuel in the air to produce a turbine exhaust stream and drive an air compressor;
processing a hot gas stream in the air compressor and an air heater to produce a regeneration gas stream;
regenerating, using the regeneration gas stream, a catalyst of a hydrocarbon dehydrogenation unit to produce a regeneration exhaust gas stream; and
processing the regeneration exhaust gas stream to produce at least a portion of a combustion gas comprising the oxidant for the endothermic chemical production process;
wherein the endothermic chemical production process includes a steam reforming process, and/or a steam cracking process.

4. The method of claim 3, wherein the processing of the hot gas stream includes:
compressing the hot gas stream in the air compressor to produce a high pressure gas stream; and
combusting a fuel with the high pressure gas stream to produce the regeneration gas stream.

5. The method of claim 3, wherein the regeneration gas stream comprises 1 to 15 vol. % oxygen gas.

6. The method of claim 5, wherein the regeneration gas stream is at a temperature of 600 to 730° C. and a pressure of 1 to 2 bar.

7. The method of claim 2, wherein the hot gas stream is a hot gas from a waste air vent of an MTBE production unit.

8. The method of claim 7, wherein the hot gas from the waste air vent of the MTBE production unit comprises 1 to 15 wt. % oxygen gas.

9. The method of claim 2, wherein the processing of the regeneration exhaust gas stream comprises:
cooling and/or removing nitrogen oxides from the exhaust gas stream in an air waste boiler and NOX removal unit to produce a first cooled exhaust stream;
flowing at least a portion of the first cooled exhaust stream to form a flue gas stream; and
generating, by a baffle damper installed upstream to an air waste heat boiler stack, a back pressure in the flue gas stream such that the flue gas stream flows to (1) an outlet of forced draft fan for a stream reformer and/or (2) duct work of a furnace of steam cracker.

10. The method of claim 9, wherein the back pressure is configured to drive flow of the combustion gas to the endothermic chemical production process.

11. The method of claim 10, wherein the back pressure is in a range of about 500-800 millimeters of water column.

12. The method of claim 2, wherein the endothermic chemical production process includes a steam cracking process and/or a steam reforming process, wherein the steam reforming process includes a steam reforming process for producing methanol, a steam reforming process for producing ammonia, a steam reforming process for producing steel, a steam reforming process for producing 2-ethylhexanol, or combinations thereof.

13. The method of claim 2, wherein the dehydrogenation unit includes an n-butane dehydrogenation unit, an isobutane dehydrogenation unit, a propane dehydrogenation unit, an isopentane dehydrogenation unit, or combinations thereof.

14. The method of claim 2, wherein the hot gas from the waste air vent from the MTBE production unit further comprises nitrogen, carbon dioxide, carbon monoxide, oxides of sulfur and/or nitrogen, or combinations thereof.

15. The method of claim 2, wherein the hot gas from the waste air vent of the MTBE production unit is at a temperature of 150 to 250° C.

16. The method of claim 2, wherein the combustion gas comprises 15 to 21 vol. % oxygen, and the combustion gas is at a temperature of 150 to 250° C. and a pressure of 200 to 300 millimeters water column.
